(19) United States
(12) Patent Application Publication
(10) Pub. No.: US 2012/0219265 A1
(43) Pub. Date: Aug. 30, 2012

(54) METHOD AND APPARATUS FOR USE WITH VIDEO SEQUENCES

(75) Inventors: Madhvanath Sriganesh, Bangalore (IN); Dey Prasenjit, Bangalore (IN); Dinesh Mandalapu, Bangalore (IN); Subramanian Anbumani, Bangalore (IN)

(73) Assignee: HEWLETT-PACKARD DEVELOPMENT CO., L.P., Houston, TX (US)

(21) Appl. No.: 13/505,261

(22) PCT Filed: Oct. 30, 2009
(86) PCT No.: PCT/IN2009/000620

§ 371 Date: Apr. 30, 2012

(51) Int. Cl. H04N 5/775; H04N 9/80

(52) U.S. Cl. 386/230; 386/239; 386/E05.07; 386/E09.011

(57) ABSTRACT

A video sequence is played and the video sequence may be displayed on a visual output device. A user attention level is calculated for a section of the video sequence, and the user attention level is associated with the section of the video sequence.

### BACKGROUND

An ever increasing number of films, videos, and video sequences (hereinafter referred to generally as video, clips) are available to users of computing devices over computer networks such as the Internet, for example through video hosting websites.

Given the diversity of available video clips, many such websites categorize video clips into different genres and additionally allow users to add a rating and comments to be associated with a video clip.

Whilst for short clips, a simple single rating is generally helpful, for longer clips a single rating does not indicate whether the whole video clip was of interest to a viewer. For example, a long clip having a high rating may contain sections which are of low interest to a viewer. Similarly, a long clip having a low rating may contain sections which are of high interest to a viewer.

### BRIEF DESCRIPTION

Embodiments of the invention will now be described, by way of non-limiting example only, with reference to the accompanying drawings, in which:

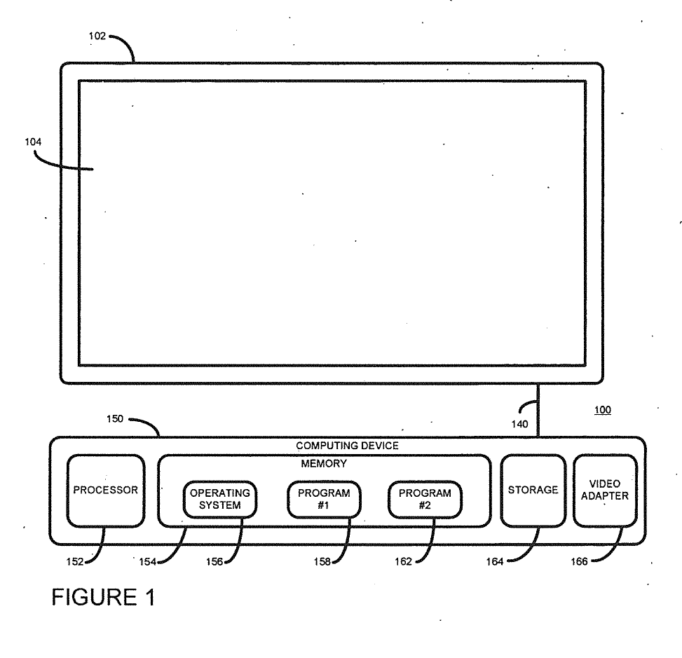

FIG. 1 is a block diagram of a computing system;

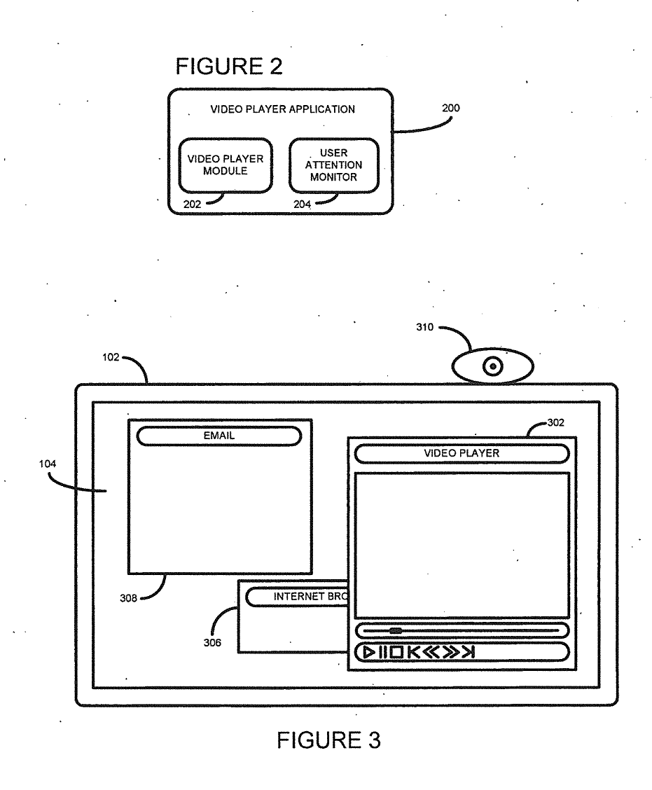

FIG. 2 is block diagram of a video player module according to an embodiment of the present invention;

FIG. 3 is an example screen shot of various computer applications executed by the computing device in a windowed environment and displayed on a display device according to an embodiment of the present invention;

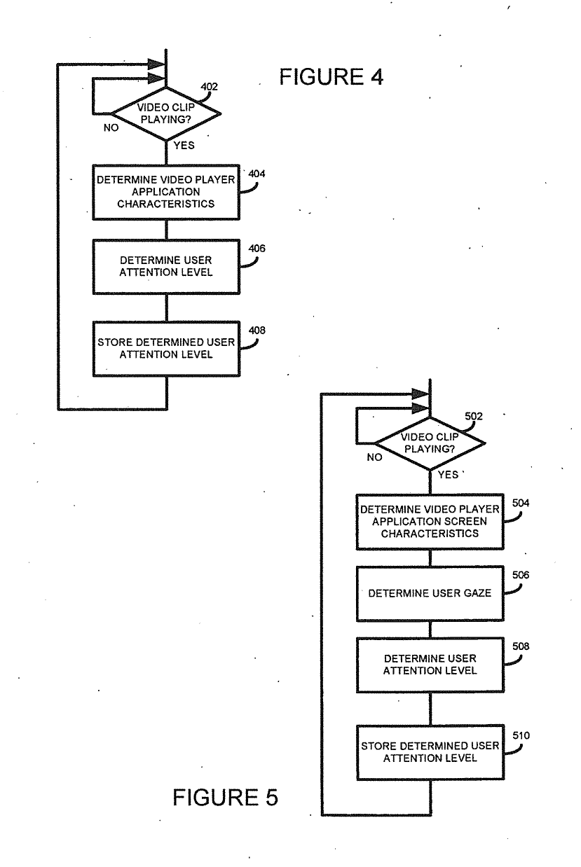

FIG. 4 is a flow diagram showing example processing steps taken by a user attention monitor according to one embodiment of the present invention;

FIG. 5 is a flow diagram showing example processing steps taken by, the user attention monitor according a further embodiment of the present invention;

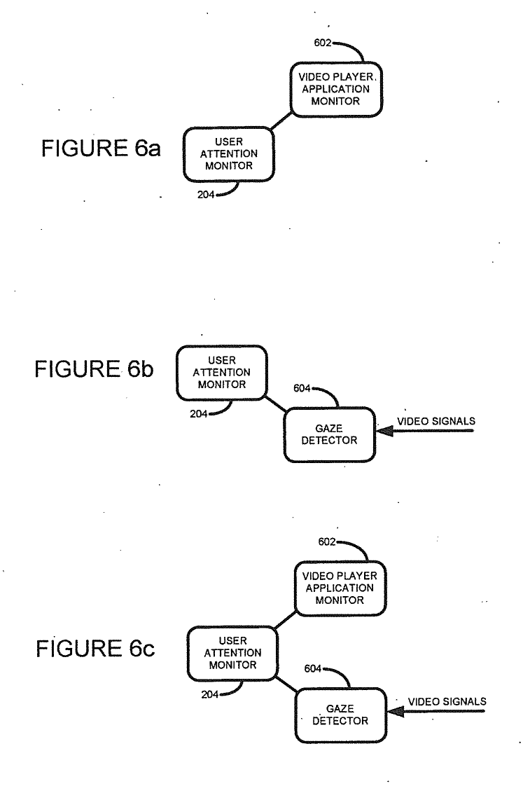

FIG. 6a is a block diagram showing a video player application monitor according to one embodiment of the present invention;

FIG. 6b is a block diagram showing a video player application monitor according to one embodiment of the present invention;

FIG. 6c is a block diagram showing a video player application monitor according to one embodiment of the present invention;

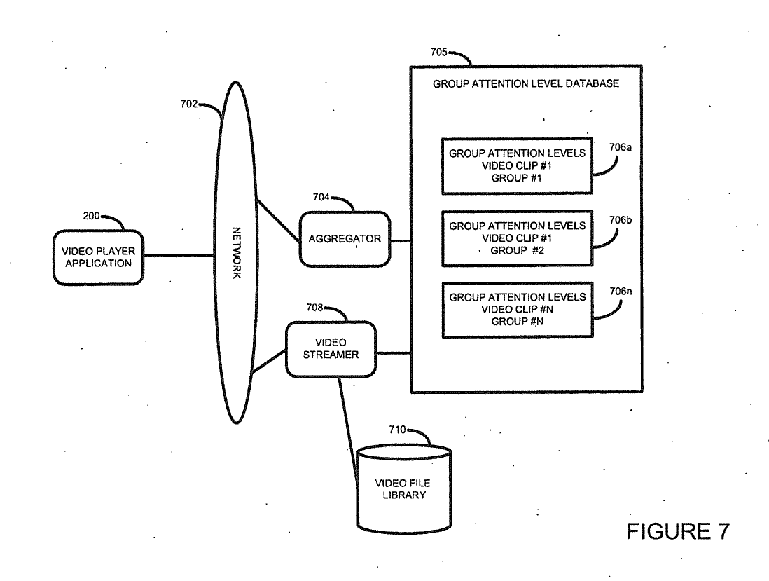

FIG. 7 is a block diagram of an aggregator module according to one embodiment of the present invention;

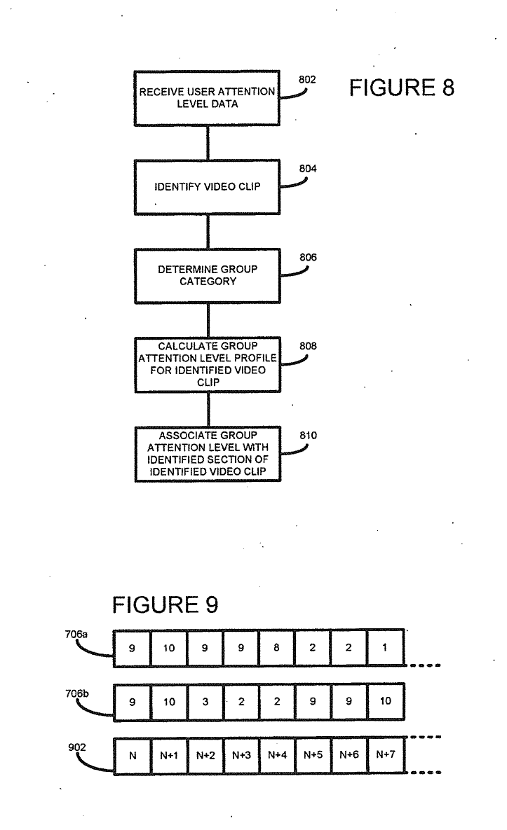

FIG. 8 is a flow diagram showing example processing steps taken by an aggregator module according to an embodiment of the present invention;

FIG. 9 is block diagram of a video clip associated with user attention profile levels according to one embodiment of the present invention;

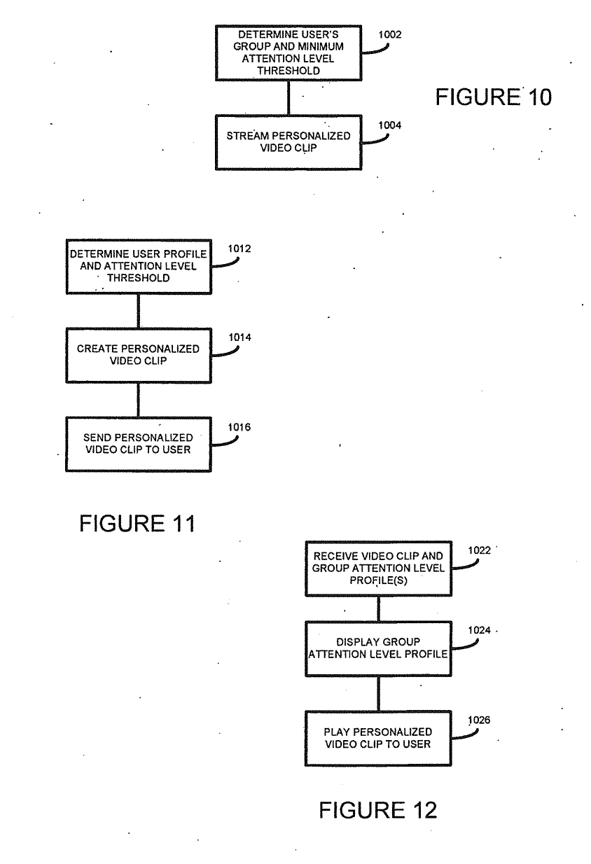

FIG. 10 is a flow diagram showing example processing steps taken by a video clip streaming application according to an embodiment of the present invention;

FIG. 11 is a flow diagram showing example processing steps taken by a video processing module according to an embodiment of the present invention; and

FIG. 12 is a flow diagram showing example processing steps taken by a video player application according to an embodiment of the present invention.

### SUMMARY OF THE INVENTION

According to one aspect of the present invention, there is provided a method of analyzing a video sequence on a computing device associated with a visual output device. The method comprises playing the video sequence through a video player application, the video sequence being displayed on the visual output device; calculating a user attention level for a section of the video sequence; and associating the calculated user attention level with the section of the video sequence.

According to a second aspect of the present invention, there is provided apparatus for analyzing a video sequence, the apparatus configured to operate in accordance with the above method.

According to a third aspect of the present invention, there is provided a method of associating user attention level data with a video sequence. The method comprises receiving user attention data identifying a video sequence and section thereof, identifying a group to which the user attention data is related, calculating, for the identified section of the video sequence, using the received user attention data, a group attention level, and associating the calculated group attention level data with the identified section of the video sequence.

According to a fourth aspect of the present invention, there is provided apparatus for associating user attention level data with a video sequence, configured to operate in accordance with the above-described method.

According to a fifth aspect of the present invention, there is provided a method of playing a video sequence. The method comprises determining for a section of the video sequence an associated user attention level, determining a minimum attention level threshold, and playing only sections of the video sequence having an associated user attention level above the determined minimum attention level threshold.

According to a sixth aspect of the present invention, there is provided apparatus for playing a video sequence configured to operate in accordance with the above-described method.

### DETAILED DESCRIPTION

Wistia Inc., of Lexington, Mass., US, provides a video clip hosting solution that produces so-called video ‘heat-maps’. A video heat-map is a temporal profile of a video clip, and is generated by monitoring the interactions a user has with the controls of a video player application used to play a video clip to a user. For instance, if a user uses the video player controls to skip over a section of the video clip or watches a section of the video clip more than once the user's actions are represented in the video heat-map using different colors.

The person on behalf of whom the video is hosted may later access a video heat-map for their video and see a graphical representation showing the number of times each section of the video clip was played by the video player application.

Video heat-maps generated in this way are only based on user interaction with the video player controls, and assumes that the user is actually watching and paying attention to the video clip whilst it is playing. However, this is not necessarily the case.

Embodiments of the present invention aim to provide a method, system, and apparatus for generating user attention level data of video clips, and for enabling the playback of video sequences having such user attention level data associated therewith.

Referring now to FIG. 1 there is shown a view of a general computing system 100.

The system 100 comprises a computing device 150 and a display device 102 to which the computing device 150 is connected through a video connector 140. The system 100 may comprise a separate computing device 150, such as a desktop personal computer or computer server, with a separate display device 102. Alternatively, the computing device 150 and display device 102 may be integrated into a single device, such as a portable, laptop, notebook, or net-book computer, portable radiotelephone, smartphone, etc. type computing device.

The computing device 150 comprises a processor 152, such as a microprocessor, a memory 154 in communication or coupled with the processor 152, and storage 164 also in communication or coupled with the processor 152. The communication between the processor 152, the memory 154 and the storage 164 may be suitably provided by an appropriate communication bus (not shown), as will be appreciated by those skilled in the art. The storage 164 may be a hard disk, solid-state drive, non-volatile memory, or any suitable equivalent storage medium. The memory 154 stores a number of different software programs 158 and 162, and an operating system 156, which are executed by the processor 152.

The computing device 150 additionally includes a video adapter 166 for generating video signals representing graphical output of the different software programs 156, 158, and 162, executed by the processor 152. The video signals output by the video adapter are input to the display device 102 via the video connector 140, and the display device 102 displays the appropriate graphical output. The computing device 150 also includes a user interface (not shown) enabling a user to make user inputs for controlling the computing device 150. The computing device 150 also includes a network adapter (not shown) for connecting the computing device 150 to a network such as the Internet.

The display device 102 displays the graphical output on a display area 104. The display device 102 may suitably be a cathode ray tube monitor, an LCD monitor, a television display, or the like.

A video player according to one embodiment of the present invention will now be described, with reference to FIG. 2. The video player is configured to generate user attention level data for sections of a video clip played through the video player. In the present embodiments the video clip is streamed from a remote video clip hosting website over a network such as the Internet, as shown in FIG. 7. In other embodiments the video clip may be stored locally, for example, in the storage 164.

The video player may be provided, as a ‘soft’ video player, for example as a computer program stored in the memory 154 of the computing device 150 and executed by the processor 152, or as a ‘hard’ video player, for example a physical video player device such as a DVD or multimedia player or the like. In the present embodiment a soft video player is described implemented as a video player application 200.

The video player application 200 comprises a video player module 202 for playing a video clip, for causing the played video clip to be displayed on the display device 102, and enabling playback of the video clip to be controlled by the user. The video player application 200 additionally comprises a user attention monitor 204, for determining or calculating a level of attention the user is paying to a section of the playing video clip.

In one embodiment, the video player application may be a plug-in application for use with an Internet browsing application. In this way, a user may navigate to a video hosting website using the Internet browsing application and may directly invoke the playing of a video clip within the browsing application through use of the plug-in video player application.

Referring now to FIG. 3 there is shown an example screen shot of various computer applications executed by the computing device 150 and displayed in a windowed environment on the display device 102. For example, FIG. 3 shows the video player application window 302, an Internet browser application window 306, and an email application window 308. As is well known within a windowed operating system environment, each computer application is displayed within a window, and application windows may typically be resized and moved around to cover or overlap other windowed applications executing at the same time.

In a first embodiment, the user attention monitor 204 is configured to determine a user attention level at discrete points or sections throughout the video clip whilst the video clip is playing. In one embodiment a user attention level may be determined for each frame of video of the video clip. In other embodiments a user attention level may be determined for, for example every second or every minute of the video clip. A user attention level is determined by determining various characteristics of the video player application 200 whilst the video clip is being played. In the present embodiment, the user attention monitor 204 comprises a video player application monitor 602, as shown in FIG. 6.

FIG. 4 is a flow diagram showing example processing steps taken by the user attention monitor 204 according to one embodiment of the present invention.

At step 402 it is determined whether a video clip is being played by the video player application 200. Once a video clip is being played various video player application characteristics are determined (step 404).

The characteristics may include, for example, screen characteristics, such as the screen coordinates of the video player application window 302, a determination of the percentage of the video player application window 302 that is visible on the display device (for instance, the video player application window 302 may be wholly or partially covered by one or more other application windows). Other screen characteristics may include, for example, the size of the video player application window 302, and whether the video player application window 302 is showing in a ‘full screen’ mode.

The characteristics may also include non-screen characteristics; such as whether the video player application 200 is the foreground application. By foreground application is meant the application which receives user input via the user interface of the computing device 150. Other non-screen characteristics may also include, for example, determining whether user input is being received through the user interface of the computing device 150 (for example, is a mouse or a keyboard being used), determining the audio volume level of the video player application 200, etc.

The characteristics are suitably those available either through the video player application 200 itself or through the operating system 156, for example through a suitable application programming interface (API).

At step 406 a user attention level is determined using each of the determined characteristics, with each of the determined user attention levels being averaged or aggregated in an appropriate manner to give a single user attention level for the particular video clip section.

For example, a user attention level from 0 to 10 may be determined for each of the determined characteristics. Each of the determined characteristics may additionally be allocated a weighting coefficient.

Below are shown a number of example video player application characteristics with their associated user attention levels and weight coefficients, for use in embodiments of the present invention.

| % of video player window visible | |
|---|---|
| (Weighting coefficient = 1) | User Attention Level |
| 0 to 25% | 0 |
| 25 to 50% | 2 |
| 50 to 95% | 6 |
| 95 to 100% | 10 |

| Video player is foreground application? | |
|---|---|
| (Weighting coefficient = 0.75) | User Attention Level |
| No | 5 |
| Yes | 10 |

| Video player window % of display device | |
|---|---|
| (Weighting coefficient = 0.80) | User Attention Level |
| <25% | 5 |
| 25 to 50% | 7 |
| 51 to 75% | 8 |
| >75% | 10 |

| Volume level | |
|---|---|
| (Weighting coefficient = 1) | User Attention Level |
| Muted | 0 |
| Un-muted | 10 |

For example, a section of the video clip during which the video player application window was 100% visible, was not the foreground application, was 100% of the size of the display device, and during which the volume was un-muted would have a user attention level of:

((10*1)+(5*0.75)+(10*0.80)+(10*1))/4=8.1

Those skilled in the art will appreciate that the above characteristics, associated user attention levels and weighting coefficients are merely exemplary and are non-limiting.

At step 408 the determined user attention level for a particular section of the video clip are stored or recorded, as described further below.

In a further embodiment of the present invention the user attention monitor 204 is configured to determine a user attention level at discrete points or sections throughout the video clip whilst the video clip is playing by determining whether the user is looking at the video player application window 302, as will be described below.

The determination of whether the user is looking at the video player application is performed, for example, by detecting and/or tracking the gaze or eye position (hereinafter referred to generally as gaze detection) of the user using the computing device 150.

As shown in FIG. 6b, the video signals from a video camera 310 are received and processed by a gaze detector module 604 of the user attention monitor 204. The gaze detector module uses any appropriate video processing techniques and algorithms to determine approximate coordinates on the display area 104 of the display device 102 where the user is looking. Those skilled in the art will appreciate that such techniques are generally well known, and will not be described further herein.

Operation of the user attention monitor 204 in accordance with a further embodiment of the present invention will now be described with further reference to FIG. 5.

At step 502 it is determined whether a video clip is being played by the video player application 200. When a video clip is being played various video player application screen characteristics are determined (step 504). The screen characteristics may include, for example, the screen coordinates of the visible area of the video player application 302 application window as displayed on the display device 102. The screen coordinates define a polygon of the visible part of the video player application 302 application window. For example, where the video player application 302 application window is fully visible the defined polygon will be a quadrilateral. Where the video player application 302 application window is only partially visible the coordinates will define a different polygon.

At step 506 the coordinates of the user's gaze are determined by the gaze detector module 604.

At step 506 a user attention level is determined by determining whether the user's gaze is within the determined visible area of the video player application 302 application window.

For example, if it is determined that the user is looking at the video player application 302 whilst the video clip is playing, a user attention level of 10 may attributed to that section of the video clip. If, however, it is determined that the user is not looking at the video player application 302, a different user attention level may be attributed to that section of the video clip.

At step 510 the determined user attention level for a particular section of the video clip are store or recorded, as described further below.

In a further alternative embodiment, the gaze detector module 604 is configured to determine (at step 506) whether a user's face is generally facing the direction of the display device 102. As above, a suitable user attention level may be attributed (step 508) to a section of a video clip depending on whether it is determined that the user's face is facing the display device 102 or not.

In a still further embodiment, the gaze detector module 604 is configured to determine the eye position or facial position of more than one user watching the video clip. In this case, a suitable user attention level may be attributed (step 508) based, for example, on an aggregation of the user attention levels, of each of the viewers detected or identified by the gaze detector module 604.

Those skilled in the art will appreciate that the gaze detection techniques described above may be performed, for example, by processing video images of the user obtained using a suitable video camera 310, such as a webcam, for example mounted opposite the user and in proximity to the display device. The webcam may, for example, be integrated into frame of the display device where the display device is integrated into a laptop or other portable computing device. Video signals from the video camera 310 are input to the computing device 150 through an appropriate interface (not shown).

In a yet further embodiment, the user attention monitor module 204 comprises both a video player application monitor 602 and a gaze detector module 604, as shown in FIG. 6c. In this embodiment, the determined user attention level for a section of a video clip is based on a suitable combination of the determined user attention level made by both the video player application monitor 602 and the gaze detector module 604.

In the present embodiments, where the played video clip is streamed from a remote video clip-hosting website, the determined user attention levels are stored (e.g. steps 408 and 510) in a memory and are sent back to an aggregator module 704, as shown in FIG. 7, of the video clip hosting website. The data may be sent, for example, over a network 702 such as the Internet.

The data may be sent to the aggregator module 704 in real-time or in substantially real-time, whilst the video clip is being played, or may be sent once the video clip has been watched, or at any other appropriate time. The data sent to the aggregator module 704 may include, for example, a user or group category identifier, data identifying the video clip, data identifying a section of the video clip, and user attention level data relating to the identified section of the video clip.

A group category may identify any suitable characteristics of a user, such as age range, job type, education level, level of technical expertise, socio-economic group, nationality, and the like.

As shown in FIGS. 7 and 8, the received user attention level data is received (step 802) by the aggregator module 704. Additionally, multiple users of the same or other video player applications may send user attention level data relating to the same or other video clips to the aggregator module 704.

The aggregator module 704 identifies (step 804), from the received data, the video clip and section of the video clip to which the user attention level data relates. For example, received data may include an in-point and out-point time code of the video clip to identify the video clip section to which the received user attention level data relates.

At step 806 a group category to which the received user attention level data relates is determined. For example, the group category may be determined if a group category identifier is included in the received data. Alternatively, the group category may be determined by accessing a user account associated with a user identifier included in the received data.

At step 808, the aggregator 704 calculates a group attention level for the identified section of the video clip by aggregating the received user attention level with other previously received user attention levels belong to the same group category for the same video clip section. The calculated group attention level is then associated (step 810) with the identified section of the identified video clip in any appropriate manner, for example by storing the data in a group attention level database 705.

As further user attention level data is received, the group attention level data for the appropriate video clip and sections thereof may be updated. In this way, group attention levels data 706a, 706b, and 706n, are built up over time as different users watch and provide user attention level data for different video clips.

FIG. 9 shows, for example, a portion of a video clip 902, for example stored as a video file, having video clip sections N, N+1, to N+7. First group attention level data 706a and second group attention level data 706b are shown in relation to the video clip 902.

In the present embodiment, the group attention level data and associated video clip are stored separately in separate files. In an alternative embodiment, however, the group attention level data and video clip may be stored in a single file, for example with the group attention level data being inserted into an appropriate header of the video file.

When a user wishes to view a video clip the user accesses the web site hosting the video clip, for example using a suitable Internet browsing application.

In one embodiment, the operation of which is shown in FIG. 10, a video clip streaming module 708 determines the group category to which the user is assigned and determines a user's chosen minimum attention level (step 1002). This data may be obtained, for example, by associating a user group category and a desired minimum attention level with a user account on a web site through which the streaming module is accessible. In a further embodiment, the user may be prompted to select a group category and a minimum attention level using on-screen controls.

Instead of streaming the entire selected video clip to the video player application 200, the video streaming module 708 only streams those sections of the selected video clip having a group attention level above the chosen desired attention level for the chosen group. This, advantageously, enables the user to watch a personalized version of the video clip.

In a further embodiment, the operation of which is shown in FIG. 11, the video hosting web site determines a user's group category and the user's minimum desired attention level (step 1012), as described above. A video processing module (not shown) then processes the video clip to create (step 1014) a personalized video clip file containing only those sections having a corresponding group attention level above the chosen desired attention level. The personalized video clip is then sent (step 1016) to the user either as a downloadable file, or as a streaming video clip.

In a yet further embodiment, the operation of which is shown in FIG. 12 a video streamer module 708 of the website hosting the video clip streams a video clip stored in a video file library 710, along with the associated group attention level data, to the video player application 200. The video player application 200 receives (step 1022) the video clip stream and buffers the received video clip in a memory. As the video clip is received the video player application displays (step 1024) a visual representation of the selected group attention level data. For example, if the user has previously identified himself to the video player application as having a group category of ‘engineer’, a temporal attention profile corresponding to the ‘engineer’ group category is displayed, if available in the video clip. If, for example, a selected group attention level data is not available with the video clip, an alternative or aggregated temporal attention profile may be displayed.

When the user plays (step 1026) the video clip through the video player application 200 only those sections of the video clip having a group attention level greater than the selected minimum attention level will be played to the user.

As the user watches the video clip, the user attention level for the current user is also determined for sections of the video clip and is sent back to the website hosting the video clip, as previously described above.

In this way, the viewing experience of a video clip may be automatically varied and personalized depending on the user's chosen group and the user's selected minimum attention level. For example, referring back to FIG. 9, group attention level data 904 may represent an ‘engineer’ group, and group attention level data 906 may represent a ‘marketing’ group profile.

A user having selected ‘engineer’ as the group category and ‘5’ as the minimum attention level would therefore only be shown video clip sections N, N+1, N+5, N+6, and N+7. A user having selected ‘marketing’ as the group category and ‘5’ as the minimum user attention level would therefore only be shown video clip sections N, N+1, N+2, N+3, and N+4.

Although the embodiments described above relate primarily to video clips, those skilled in the art will appreciate the embodiments are not limited thereto. For example, the techniques and processes described herein could be adapted for use with audio only files or with other types of multimedia content.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program.

Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method of analyzing a video sequence on a computing device associated with a visual output device comprising:
playing the video sequence through a video player application, the video sequence being displayed on the visual output device;
calculating a user attention level for a section of the video sequence; and
associating the calculated user attention level with the section of the video sequence.

2. The method of claim 1, wherein the step of determining a user attention level further comprises:
determining one or more characteristics of the video player application whilst the section of the video sequence is playing; and
calculating a user attention level for that section based on the one or more determined characteristics.

3. The method of claim 2, wherein the step of determining one or more characteristics comprises deter mining at least one of:
the screen coordinates of the video player application on the display device;
the percentage of the video player application visible on the display device;
whether the video player application 200 is the foreground application executing on the computing device;
the size of the video player application on the display device;
the percentage of the display device display area occupied by the video player application;
whether user input is being received through a user interface of the computing device; and
an audio volume level.

4. The method of claim 1, wherein the step of determining a user attention level further comprises:
determining one or more screen characteristics of the video player, application whilst a section of the video sequence is playing;
determining whether a user is looking at the video player application on the display device; and
calculating, for the section, a user attention level based on the one or more determined characteristics and on the determination of whether the user is looking at the video player application.

5. The method of claim 1, wherein the step of determining one or more screen characteristics of the video player application comprises determining the screen coordinates of the video player application displayed on the display device.

6. The method of claim 1, wherein the step of playing the video sequence comprises receiving the video sequence from a remote network location, the method further comprising sending the calculated user attention level to the remote network location.

7. (canceled)

8. A method of associating user attention level data with a video sequence, comprising:
receiving user attention data identifying a video sequence and section thereof;
identifying a group to which the user attention data is related;
calculating, by a processor, for the identified section of the video sequence, using the received user attention data, a group attention level; and
associating the calculated group attention level data with the identified section of the video sequence.

9. The method of claim 8, wherein the step of calculating further comprises calculating the group attention level based on the received user attention data and any previously calculated group attention level data.

10. (canceled)

11. A method of playing a video sequence comprising:
determining, by a processor, for a section of the video sequence an associated user attention level;
determining a minimum attention level threshold; and
playing only sections of the video sequence having an associated user attention level above the determined minimum attention level threshold.

12. The method of claim 11, wherein the step of determining for a section of the video sequence an associated user attention level comprises determining an associated group attention level, the method further comprising determining a group category, and wherein the step of playing only sections of the video sequence having an associated user attention is configured for playing only sections of the video sequence having an associated group attention level above the determined minimum attention level threshold.

13. The method of claim 11, wherein the step of playing comprises streaming the sections of the video sequence having an associated attention level above the determined minimum attention level threshold to a remote video player application.

14. The method of claim 11, further comprising receiving a video sequence and associated user attention level data at a video player application, the method further comprising the video player application only playing those sections of the received video sequence having an associated user attention level above the determined minimum attention level threshold.

15. (canceled)
